(19) United States
(12) Patent Application Publication
(10) Pub. No.: US 2023/0004863 A1
(43) Pub. Date: Jan. 5, 2023

(54) LEARNING APPARATUS, METHOD, COMPUTER READABLE MEDIUM AND INFERENCE APPARATUS

(71) Applicant: KABUSHIKI KAISHA TOSHIBA, Tokyo (JP)

(72) Inventors: Yasuhiro KANISHIMA, Tokyo (JP); Takashi SUDO, Fuchu Tokyo (JP); Hiroyuki YANAGIHASHI, Kawasaki Kanagawa (JP)

(73) Assignee: KABUSHIKI KAISHA TOSHIBA, Tokyo (JP)

(21) Appl. No.: 17/682,225

(22) Filed: Feb. 28, 2022

(30) Foreign Application Priority Data
Jul. 1, 2021 (JP) 2021-110283

(51) Int. Cl. G06N 20/00; G06N 7/00; G06K 9/62

(52) U.S. Cl. CPC G06N 20/00; G06N 7/005; G06K 9/6277; G06K 9/6298

(57) ABSTRACT

According to one embodiment, a learning apparatus includes a processor. The processor acquires data with a label indicating whether the data is normal data or anomalous data. The processor calculates an anomaly degree indicating a degree to which the data is the anomalous data using an output of a model for the data. The processor calculates a loss value related to the anomaly degree using a loss function based on an adjustment parameter based on a previously calculated loss value and the label. The processor updates a parameter of the model so as to minimize the loss value.

This application is based upon and claims the benefit of priority from Japanese Patent Application No. 2021-110283, filed Jul. 1, 2021, the entire contents of which are incorporated herein by reference.

### FIELD

Embodiments described herein relate to a learning apparatus, method, computer readable medium and an inference apparatus.

### BACKGROUND

Much research has been done on using machine learning for anomaly detection. In such anomaly detection using machine learning, there is a need to improve the performance of anomaly detection by utilizing generated anomalous data at the stage when the anomalous data is generated during operation.

However, when a model is updated each time in situations in which it is available in stages during the operation of anomalous data, there is a problem wherein the consistency of the model is not considered before and after the model update and the continuity of degrees of anomalies output by the models before and after the update is lost.

### BRIEF DESCRIPTION OF THE DRAWINGS

FIG. 1 is a block diagram showing a learning apparatus according to a first embodiment.

FIG. 2 is a flowchart showing training processing of the learning apparatus according to the first embodiment.

FIG. 3 is a conceptual diagram showing balance adjustment of a loss function by an adjustment parameter according to the first embodiment.

FIG. 4 is a block diagram showing an inference apparatus according to a second embodiment.

FIG. 5 is a diagram showing an example of an anomaly degree determination result by the inference apparatus according to the second embodiment.

FIG. 6 is a diagram showing an example of an image output of a reconstruction error which is a processing result of the inference apparatus according to the second embodiment.

FIG. 7 is a block diagram showing an example of a hardware configuration of the learning apparatus and the inference apparatus according to the present embodiments.

### DETAILED DESCRIPTION

In general, according to one embodiment, a learning apparatus includes a processor. The processor acquires data with a label indicating whether the data is normal data or anomalous data. The processor calculates an anomaly degree indicating a degree to which the data is the anomalous data using an output of a model for the data. The processor calculates a loss value related to the anomaly degree using a loss function based on an adjustment parameter based on a previously calculated loss value and the label. The processor updates a parameter of the model so as to minimize the loss value.

Hereinafter, the learning apparatus, method, computer readable medium, and an inference apparatus according to the present embodiments will be described in detail with reference to the drawings. In the following embodiments, the parts with the same reference signs perform the same operation, and redundant descriptions will be omitted as appropriate.

### First Embodiment

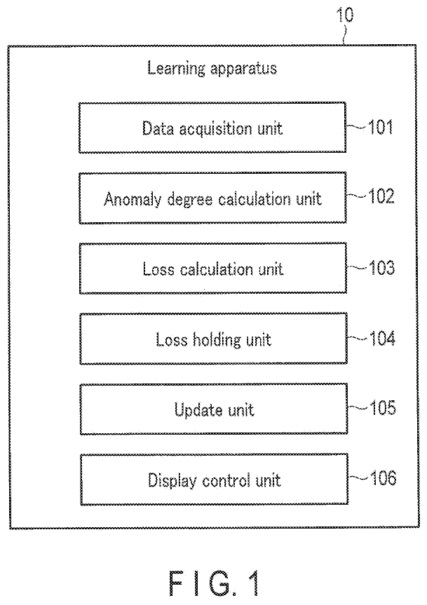

A learning apparatus according to a first embodiment will be described with reference to the block diagram of FIG. 1.

A learning apparatus 10 according to the first embodiment includes a data acquisition unit 101, an anomaly degree calculation unit 102, a loss calculation unit 103, a loss holding unit 104, an update unit 105, and a display control unit 106.

The data acquisition unit 101 acquires a data set from the outside. The data set here includes a plurality of pairs of data x used for training and a label indicating which of two classifications (normal data and anomalous data) the data is.

The anomaly degree calculation unit 102 receives a data set from the data acquisition unit 101, and uses an output of a model for the data to calculate an anomaly degree indicating a degree to which the data is anomalous data. The model here is a network model such as an autoencoder whose task is to detect anomalies.

The loss calculation unit 103 receives the label associated with the data for which the anomaly degree has been calculated from the data acquisition unit 101, the anomaly degree from the anomaly degree calculation unit 102, and a previously calculated loss value from the loss holding unit 104 to be described later, respectively. The loss calculation unit 103 calculates a loss value related to the anomaly degree by using a loss function. A loss function is a function based on an adjustment parameter based on a loss value calculated in previous processing and a label.

The loss holding unit 104 holds one or more loss values calculated by the loss calculation unit 103 in past processing.

The update unit 105 receives a loss value from the loss calculation unit 103, and updates a parameter of the model so as to minimize the loss value. When the update unit 105 terminates the updating of the model parameter based on a predetermined condition, the training of the model is completed and a trained model is generated.

The display control unit 106 controls, for example, to display information on the anomaly degree calculated by the anomaly degree calculation unit 102, the loss function during training of the model, and the loss value on an external display. The learning apparatus 10 may include a display unit (not shown) and display the information on that display unit.

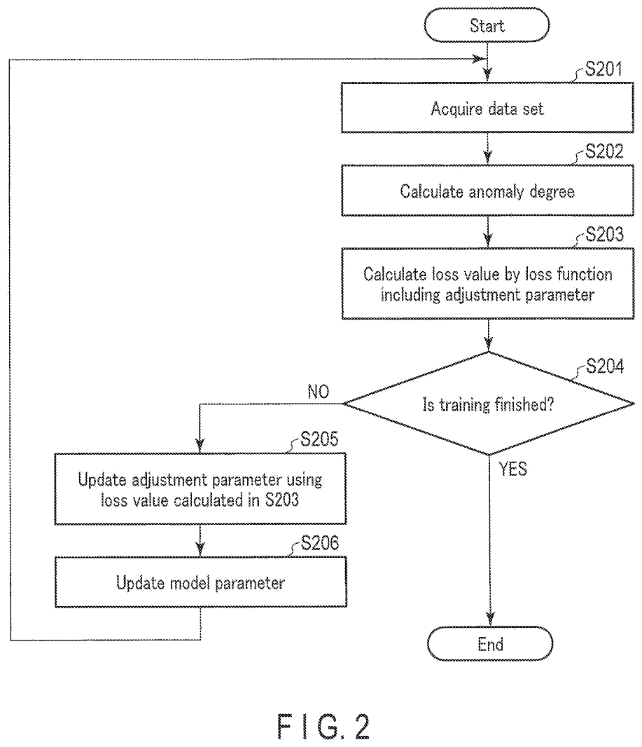

Next, training processing of the learning apparatus 10 according to the first embodiment will be described with reference to the flowchart of FIG. 2.

Note that the present embodiment aims to generate a trained model for performing an anomaly detection task, but the present embodiment is not limited thereto. For example, if it is a machine learning model for a task that makes a binary judgment such as separating two types of products or judging positive/negative, the learning apparatus 10 according to the present embodiment can be applied by setting a degree to which the classification is one of the two classifications (a degree of deviation from a classification), and a desired trained model can be generated.

Further, in the training processing of the learning apparatus 10 shown in FIG. 2, if there is no anomalous data before operation, a model is generated by unsupervised training with only correct answer data. After that, if anomalous data can be obtained during the operation, the training processing shown in FIG. 2 is executed by supervised training in which normal data is labeled as normal and anomalous data is labeled as anomalous. If the anomalous data can be obtained even before the operation, the training processing shown in FIG. 2 may be executed in the same manner. The training processing may be executed every time anomalous data is obtained during the operation, or may be executed at a timing at which a predetermined number of anomalous data pieces are obtained. Alternatively, the training processing may be executed at predetermined intervals such as every six months.

In step S201, the data acquisition unit 101 acquires a data set. Specifically, X={xm, ym} is given as data set X including m (m is a natural number of 2 or more) data pieces. Here, data xn is the nth (n is a natural number of 1 or more, 1≤n≤m) piece of data, and each piece of data has a D-dimensional feature vector. That is, xn=[xn1, xn2, . . . , xnD]. For example, when the data xn is a monochrome image of 64×64 pixels, it has a feature vector for each pixel, that is, D=64×64=4096 feature vectors. A label yn is the nth (n is a natural number of 1 or more, 1≤n≤m) label, and yn=0 indicates normal data, and yn=1 indicates anomalous data.

In step S202, the anomaly degree calculation unit 102 calculates an anomaly degree of the data. For the anomaly degree, for example, when a model is an autoencoder, a reconstruction error may be used. If a model is a variational autoencoder, a negative log-likelihood of probability distribution may be used.

Specifically, it is assumed that the model is an autoencoder. An anomaly degree S(xn), which is a reconstruction error, may be expressed by equation (1), for example, by using a mean square error between data and an output of the autoencoder.

S(xn)=∥xn−f(xn,θ)∥₂²/D (1)

θ is a parameter of a model. f(xn, θ) is an output when the data xn is input to the autoencoder having the parameter θ. That is, if xn is an image, a root mean square of a difference value for each pixel constituting the image is the reconstruction error. The anomaly degree may be expressed as a likelihood function. It suffices that the anomaly degree calculation unit 102 can calculate, as the anomaly degree, a value which is low when a probability of appearance of the data is high, that is, when the data is normal, and which is high when the probability of appearance of the data is low, that is, when the data is anomalous.

In step S203, the loss calculation unit 103 calculates a loss value from the anomaly degree calculated in step S202 using a loss function. The loss function can be expressed by, for example, equation (2).

l(xn)=(1−yn)S(xn)−yn logₑ(1−e^{-αS(xn)})/α (2)

l(xn) is a loss value, and a is an adjustment parameter to be described later.

The loss function of equation (2) is designed such that the smaller the loss value l(xn), the lower the anomaly degree for normal data, and as the loss value l(xn) becomes smaller, the anomaly degree for anomalous data becomes higher than that of the normal data.

The loss function is not limited to equation (2), and may be any function that calculates a low value for normal data and a high value for anomalous data by a part of increasing according to the anomaly degree with respect to the normal data and a part of decreasing according to the anomaly degree with respect to the anomalous data.

Here, in equation (2), the first term “(1−yn)S(xn)” on the right side is also referred to as a normal label term, which is related to a loss of a normal label indicating normality. Similarly, the second term “−yn logₑ(1−e^{-αS(xn)})/α” is also referred to as an anomaly label term, which is related to a loss of an anomaly label indicating anomaly. The adjustment parameter α can be expressed by, for example, equation (3).

α=logₑ2/(Σlprev(xn)/D) (3)

Here, lprev(xn) is a loss value one step previous. “One step previous” is assumed to be, for example, one epoch or one iteration previous in training of a model. Specifically, when one step previous is one epoch previous, lprev(xn) is an average value of loss values calculated in one epoch. A value based on a loss value is not limited to an average value, but may be a statistic such as a combination of a maximum value or an average value and a standard deviation.

In step S204, the update unit 105 determines whether or not the training is finished. In the training completion determination, for example, it may be determined that training is finished when the training of a predetermined number of epochs is completed, it may be determined that the training is finished when the loss value l(xn) is equal to or less than a threshold value, or it may be determined that the training is finished when a decrease in the loss value converges. When the training is finished, the parameter update is terminated and the processing ends. Thereby, a trained model is generated. On the other hand, if the training is not finished, the process proceeds to step S205.

In step S205, the update unit 105 updates the adjustment parameter α using the loss value calculated in step S203. When minimizing the loss value l(xn) calculated from the loss function of the above equation (2), if it is minimized without considering a balance between the first term and the second term on the right side of equation (2), that is, the normal label term and the anomaly label term, there is a case in which either minimization of the loss value for normal data or minimization of the loss value for anomalous data may act predominantly. Thus, in minimizing the loss value l(xn), the update unit 105 adjusts the adjustment parameter a so that the first term and the second term on the right side of equation (2) can be balanced.

Specifically, for example, it suffices that the adjustment parameter α is updated so that, of the loss function, a loss function related to normal data and a loss function related to anomalous data intersect at a value based on a previously calculated loss value.

In step S206, the update unit 105 updates the parameter θ of the model, specifically, a weight and bias of a neural network, etc. by means of a gradient descent method and an error backpropagation method so as to minimize the loss value l(xn) to be calculated by the loss function. After that, the process returns to step S201, and the processes from step S201 to step S206 are repeatedly executed for the next data set.

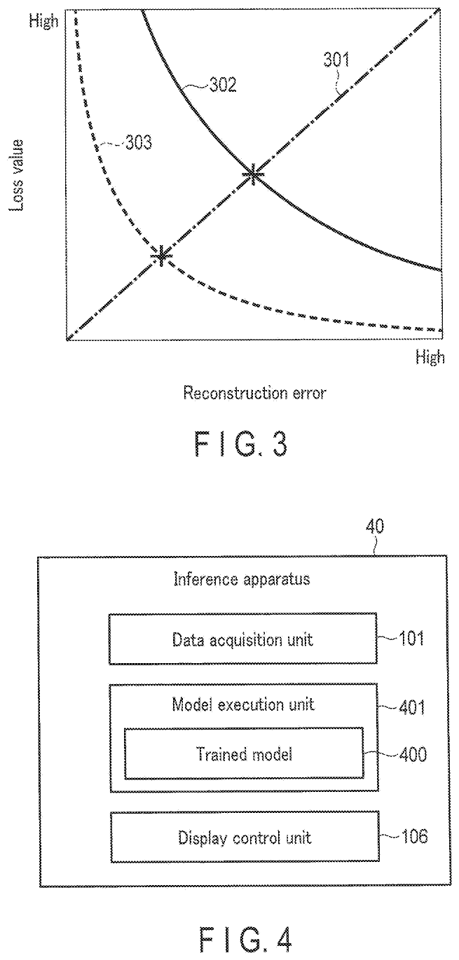

Next, the balance adjustment of the loss function by the adjustment parameter a will be described with reference to the conceptual diagram of FIG. 3.

FIG. 3 is a graph of the loss function expressed by the above equation (2), in which the ordinate axis indicates the loss value and the abscissa axis indicates the reconstruction error (the anomaly degree in the present embodiment).

Since the smaller the reconstruction error is, the more the normal data can be reproduced, a graph 301 of the normal label term is designed so that when the reconstruction error is small, the loss value is also small. That is, it is represented by a linear graph in which the loss value increases in proportion to the reconstruction error. On the other hand, a graph 302 and a graph 303 of the anomaly label term are loss values related to anomalous data, and it can be said that the larger the reconstruction error is, the farther the anomalous data is from the normal data. Therefore, the graphs are designed so that when the reconstruction error is large, the loss value is small. Further, a difference between the graph 302 and the graph 303 occurs because the curve of the anomaly label term is adjusted by a difference in value of the adjustment parameter α. Hereinafter, the anomaly label term will be described using the graph 302 as an example.

Here, an intersection of the graph 301 and the graph 302 indicates that the loss values of the normal label term and the anomaly label term match. That is, the model parameter is updated by the adjustment parameter α such that the graph 301 and the graph 302 intersect at a loss value one step previous and the loss value becomes small, so that a parameter that minimizes the loss value can be calculated while maintaining the balance between the loss value due to the normal label term and the loss value due to the anomaly label term.

Since the adjustment parameter a is based on a previously calculated loss value and is incorporated into the loss function, it is automatically calculated in the training process of the model. For example, the display control unit may display a graph related to the loss function as in FIG. 3 and a user may specify a loss value existing on the graph 301 of the previously calculated normal label term so that a curve in which the anomaly label term intersects the specified point can be calculated.

According to the first embodiment described above, a parameter of a model is trained by using a loss function including an adjustment parameter based on a loss value one step previous. Specifically, a parameter such as a weight of the model that minimizes a loss value calculated by the loss function using the adjustment parameter is determined, thereby determining a parameter in which a balance between a normal label term and an anomaly label term in the loss function is well judged.

As a result, without biased training such as training in which an anomaly label dominates, a training effect by anomalous data can also be obtained while ensuring consistency with the trained model trained by unsupervised training with only normal data when there is no anomalous data. That is, the performance of the model can be improved while ensuring the consistency of the model.

### Second Embodiment

A second embodiment shows an example of executing an inference using the trained model trained by the learning apparatus of the first embodiment.

A block diagram of an inference apparatus according to the second embodiment is shown in FIG. 4.

An inference apparatus 40 shown in FIG. 4 includes a data acquisition unit 101, a model execution unit 401, and a display control unit 106.

The data acquisition unit 101 acquires target data to be processed. For example, the target data is image data of a product for which it is desired to determine whether or not it is anomalous data.

The model execution unit 401 includes a trained model 400 generated by the learning apparatus 10 according to the first embodiment. The model execution unit 401 acquires target data from the data acquisition unit 101, inputs that target data to the trained model 400 to execute inference, and outputs an anomaly degree. Here, it is assumed that the trained model 400 is a trained autoencoder.

Specifically, a parameter of the trained model determined by the update unit 105 is θ\hat{ }. The superscript expresses that “\hat{ }” is added directly above a character. The parameter θ\hat{ } and target data x*n for which the anomaly degree is to be calculated are input to the model execution unit 401. With the trained model of that parameter θ\hat{ }, the anomaly degree for the target data x*n is calculated by, for example, equation (4).

S(xn)=∥x*n−f(x*n,\hat{θ})∥₂²/D (4)

Further, the model execution unit 401 may determine whether or not the data is anomalous data based on the anomaly degree and output a determination result. For example, if the anomaly degree is equal to or greater than a threshold value, it can be determined that the target data x*n is anomalous data. In contrast, if the anomaly degree is less than the threshold value, it can be determined that the target data x*n is normal data.

The display control unit 106 receives the determination result from the model execution unit 401, and outputs the determination result to the outside.

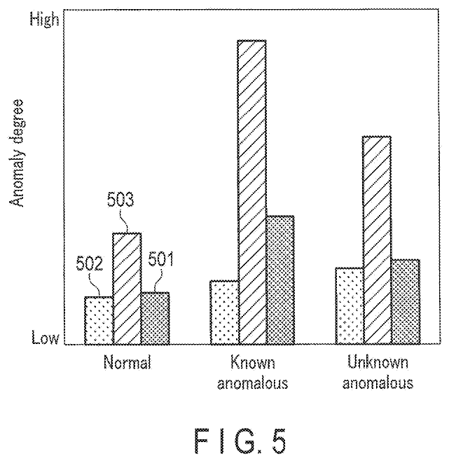

Next, the anomaly degree determination result by the inference apparatus 40 according to the second embodiment will be described with reference to the graph of FIG. 5.

A graph 501 is a graph of a calculation result of an anomaly degree by the inference apparatus 40 according to the second embodiment including the trained model according to the first embodiment. A graph 502 is a graph of a calculation result before the trained model according to the first embodiment is operated, the calculation result being of an anomaly degree by a trained model which is an autoencoder trained with only normal data before anomalous data is obtained. A graph 503, as a graph of a comparative example, is a graph of a calculation result of an anomaly degree by a trained model generated by training without an adjustment parameter in a loss function including a normal label term and an anomaly label term.

FIG. 5 is a result of inputting three types of normal data, known anomalous data, and unknown anomalous data each into the trained models by which the results of the graphs 501 to 503 were obtained, and executing inference by the trained models. In a case of the trained model according to the first embodiment by which the result of the graph 501 is obtained and the trained model as the comparative example by which the result of the graph 503 is obtained, the normal data and the known anomalous data are normal data and anomalous data used for training the model, respectively. The unknown anomalous data is anomalous data that is not involved in training the model.

On the other hand, in a case of the trained model of the autoencoder by which the result of the graph 502 is obtained, since it is trained with only normal data, the normal data is data used for training the model, and the known anomalous data and the unknown anomalous data are anomalous data that are not involved in training the model.

First, looking at the calculation result of the anomaly degree for the normal data on the left side of FIG. 5, the graph 501 has almost the same anomaly degree as the graph 502. Thus, it can be said that the trained model for the graph 501 and the trained model for the graph 502 are highly consistent in inferring the normal data. On the other hand, the graph 503 has a higher anomaly degree than the graph 501 and the graph 502, despite the processing result for the normal data. This is because a reconstruction error of the normal data increases as a reconstruction error of the anomalous data becomes maximized. Thus, it can be said that the autoencoder related to the graph 502 and the trained model related to the graph 503 have low consistency.

Furthermore, looking at the calculation results of the anomaly degree for the known anomalous data in the center of FIG. 5 and the unknown anomalous data on the right side of FIG. 5, the graph 501 has a higher anomaly degree than the graph 502 in each result. Thus, the trained model according to the present embodiment of the graph 501 can determine the anomalous data with a higher accuracy than the autoencoder related to the graph 502.

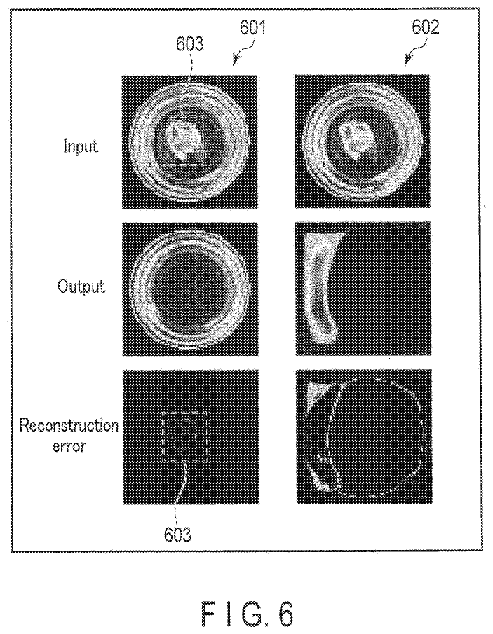

Next, an example of an image output of a reconstruction error will be described with reference to FIG. 6.

FIG. 6 shows, in order from the top, (Input) image data of target data input to a trained model, (Output) image data output from the trained model, and (Reconstruction error) image data that is a difference between the image of the target data and the trained model output. It is assumed that the target data is anomalous data including an anomalous region 603.

An image group 601 is image data related to the trained model according to the second embodiment, and an image group 602 is image data related to a trained model trained without an adjustment parameter of a loss function in the same manner as the graph 503. In the trained model according to the second embodiment, the anomalous region 603 included in the target data does not exist in the output from the trained model. The image data of the reconstruction error, which is the difference between the input image data and the output image data, includes the anomalous region 603, and accurate anomaly detection is performed.

On the other hand, in the trained model trained without an adjustment parameter of a loss function, it can be seen that the output cannot reproduce the normal data and the anomalous region 603 cannot be correctly extracted even in the reconstruction error.

According to the second embodiment described above, inference is executed by the trained model including a parameter generated in the first embodiment, so that an anomaly degree for known anomalous data is increased, while consistency with a trained model trained with only normal data can be ensured. In addition, it becomes easy to determine an anomaly part from the reconstruction error.

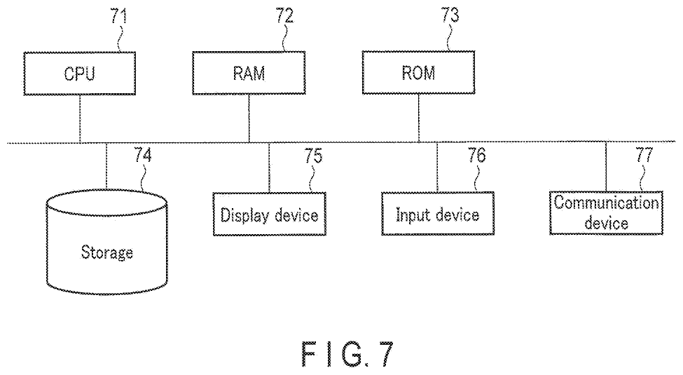

Next, FIG. 7 will be referred to for explaining an exemplary hardware configuration of the learning apparatus 10 and the inference apparatus 40 according to the foregoing embodiments.

The learning apparatus 10 and the inference apparatus 40 include a central processing unit (CPU) 71, a random access memory (RAM) 72, a read only memory (ROM) 73, a storage 74, a display device 75, an input device 76, and a communication device 77, which are connected to one another via a bus.

The CPU 71 is a processor adapted to execute arithmetic operations and control operations according to one or more programs. The CPU 71 uses a prescribed area in the RAM 72 as a work area to perform, in cooperation with one or more programs stored in the ROM 73, the storage 74, etc., operations of the components of the learning apparatus 10 and the inference apparatus 40 described above.

The RAM 72 is a memory which may be a synchronous dynamic random access memory (SDRAM). The RAM 72, as its function, provides the work area for the CPU 71. Meanwhile, the ROM 73 is a memory that stores programs and various types of information in such a manner that no rewriting is permitted.

The storage 74 is one or any combination of storage media including a magnetic storage medium such as a hard disc drive (HDD) and a semiconductor storage medium such as a flash memory. The storage 74 may be an apparatus adapted to perform data write and read operations with a magnetically recordable storage medium such as an HDD and an optically recordable storage medium. The storage 74 may conduct data write and read operations with storage media under the control of the CPU 71.

The display device 75 may be a liquid crystal display (LCD), etc. The display device 75 is adapted to present various types of information based on display signals from the CPU 71.

The input device 76 may be a mouse, a keyboard, etc. The input device 76 is adapted to receive information from user operations as instruction signals and send the instruction signals to the CPU 71.

The communication device 77 is adapted to communicate with external devices under the control of the CPU 71.

Instructions in the processing steps described for the foregoing embodiments may follow a software program. It is also possible for a general-purpose computer system to store such a program in advance and read the program to realize the same effects as provided through the control of the learning apparatus and the inference apparatus described above. The instructions described in relation to the embodiments may be stored as a computer-executable program in a magnetic disc (flexible disc, hard disc, etc.), an optical disc (CD-ROM, CD-R, CD-RW, DVD-ROM, DVD±R, DVD±RW, Blu-ray (registered trademark) disc, etc.), a semiconductor memory, or a similar storage medium. The storage medium here may utilize any storage technique provided that the storage medium can be read by a computer or by a built-in system. The computer can realize the same behavior as the control of the learning apparatus and the inference apparatus according to the above embodiments by reading the program from the storage medium and, based on this program, causing the CPU to follow the instructions described in the program. Of course, the computer may acquire or read the program via a network.

Note that the processing for realizing each embodiment may be partly assigned to an operating system (OS) running on a computer, database management software, middleware (MW) of a network, etc., according to an instruction of a program installed in the computer or the built-in system from the storage medium.

Further, each storage medium for the embodiments is not limited to a medium independent of the computer and the built-in system. The storage media may include a storage medium that stores or temporarily stores the program downloaded via a LAN, the Internet, etc.

The embodiments do not limit the number of the storage media to one, either. The processes according to the embodiments may also be conducted with multiple media, where the configuration of each medium is discretionarily determined.

The computer or the built-in system in the embodiments is intended for use in executing each process in the embodiments based on one or more programs stored in one or more storage media. The computer or the built-in system may be of any configuration such as an apparatus constituted by a single personal computer or a single microcomputer, etc., or a system in which multiple apparatuses are connected via a network.

Also, the embodiments do not limit the computer to a personal computer. The “computer” in the context of the embodiments is a collective term for a device, an apparatus, etc., which are capable of realizing the intended functions of the embodiments according to a program and which include an arithmetic processor in an information processing apparatus, a microcomputer, and so on.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising a processor configured to:
acquire data with a label indicating whether the data is normal data or anomalous data;
calculate an anomaly degree indicating a degree to which the data is the anomalous data using an output of a model for the data;
calculate a loss value related to the anomaly degree using a loss function based on an adjustment parameter based on a previously calculated loss value and the label; and
update a parameter of the model so as to minimize the loss value.

2. The apparatus according to claim 1, wherein
a probability of appearance of the normal data is higher than a probability of appearance of the anomalous data, and
the processor calculates the anomaly degree to be low for the normal data and to be high for the anomalous data.

3. The apparatus according to claim 1, wherein the processor calculates, as the anomaly degree, a reconstruction error when the model is an autoencoder, and a negative log-likelihood of probability distribution when the model is a variational autoencoder.

4. The apparatus according to claim 1, wherein the processor calculates a low value for the normal data and a higher value than the low value of the normal data for the anomalous data, using, as the loss function, a function that increases according to the anomaly degree with respect to the normal data with a high probability of appearance and decreases according to the anomaly degree with respect to the anomalous data with a lower probability of appearance than the normal data.

5. The learning apparatus according to claim 2, wherein the processor updates the adjustment parameter so that a first part of the loss function related to the normal data and a second part of the loss function related to the anomalous data intersect at a value based on the previously calculated loss value.

6. The apparatus according to claim 1, wherein the processor calculates a value based on the previously calculated loss value based on a statistic of previously calculated loss values.

7. The apparatus according to claim 1, wherein the previously calculated loss value is a loss value one epoch previous or a loss value one iteration previous in training of the model.

8. A learning method comprising:
acquiring data with a label indicating whether the data is normal data or anomalous data;
calculating an anomaly degree indicating a degree to which the data is the anomalous data using an output of a model for the data;
calculating a loss value related to the anomaly degree using a loss function based on an adjustment parameter based on a previously calculated loss value and the label; and
updating a parameter of the model so as to minimize the loss value.

9. A non-transitory computer readable medium including computer executable instructions, wherein the instructions, when executed by a processor, cause the processor to perform a method comprising:
acquiring data with a label indicating whether the data is normal data or anomalous data;
calculating an anomaly degree indicating a degree to which the data is the anomalous data using an output of a model for the data;
calculating a loss value related to the anomaly degree using a loss function based on an adjustment parameter based on a previously calculated loss value and the label; and
updating a parameter of the model so as to minimize the loss value.

10. An inference apparatus comprising a processor configured to:
acquire target data to be processed; and
calculate an anomaly degree of the target data using a trained model generated by the learning apparatus according to claim 1.

11. The apparatus according to claim 10, wherein the processor is further configured to control display of the anomaly degree.
